(19) United States
(12) Patent Application Publication
(10) Pub. No.: US 2025/0180769 A1
(43) Pub. Date: Jun. 5, 2025

(54) DETECTION OF LOW RESISTIVITY PAY ZONES USING SPECTRAL INDUCED POLARIZATION METHOD

(71) Applicant: KING FAHD UNIVERSITY OF PETROLEUM AND MINERALS, Dhahran (SA)

(72) Inventors: Sara KELLAL, Dhahran (SA); Panagiotis KIRMIZAKIS, Dhahran (SA); Ammar EL-HUSSEINY, Dhahran (SA); Panteleimon SOUPIOS, Dhahran (SA); Mohamed MAHMOUD, Dhahran (SA)

(73) Assignee: KING FAHD UNIVERSITY OF PETROLEUM AND MINERALS, Dhahran (SA)

(21) Appl. No.: 18/528,048

(22) Filed: Dec. 4, 2023

(51) Int. Cl. G01V 1/30; G01V 3/24; G01V 3/38

(52) U.S. Cl. CPC G01V 1/306; G01V 3/24; G01V 3/38

(57) ABSTRACT

A method of subsurface formation characterization is described. The method includes obtaining spectral induced polarization (SIP) measurements of a volume of a subsurface formation at a plurality of frequencies to determine a frequency-dependent complex (FDC) impedance value of a matrix material in the volume of the subsurface formation. The method further includes determining whether the volume is a low resistivity pay (LRP) zone with a formation resistivity index≤2, by analyzing the FDC impedance value of the matrix material, and identifying the volume of the subsurface formation as the LRP zone when the FDC impedance exhibits a dispersion at increasing frequencies. The FDC impedance value is substantially constant before the dispersion and increases by at least one order of magnitude over one order of magnitude of the increasing frequencies in the dispersion.

### BACKGROUND

### Technical Field

The present disclosure is directed to detecting low resistivity pay zones using spectral induced polarization method.

### Description of Related Art

The “background” description provided herein is for the purpose of generally presenting the context of the disclosure. Work of the presently named inventors, to the extent it is described in this background section and aspects of the description which may not otherwise qualify as prior art at the time of filing, are neither expressly nor impliedly admitted as prior art against the present invention.

The existence of low resistivity pay (LRP) zones presents an ongoing challenge in formation characterization, impacting the exploration and exploitation of oil and gas resources. The term “LRP” zone relates to a pay zone where the resistivity of the formation (Rt) is similar to the resistivity of the neighboring water zone (Ro). This similarity results in a low formation resistivity index I(I=Rt/Ro), making it difficult to differentiate between oil-bearing and water-bearing zones. In LRP zones, the resistivity index I is typically less than or equal to two, compared to the normal pay zone where the resistivity index I is equal to or greater than three. These LRP zones often go unnoticed or are overlooked using conventional logging, processing, and interpretation methods due to various geological factors that affect the conductivity measurements. These factors include the presence of freshwater or high salinity water in the formation, the presence of a clay mineral, a high shale volume, the presence of conductive minerals in the formations, the influence of irreducible water in micro-porosity and fine grains, as well as engineering factors such as high invasion or hole collapse.

The difficulty in evaluating LRP zones lies in obtaining accurate readings of formation resistivity, measuring shaliness, and precisely calculating water content. Over the years, researchers have attempted to address this challenge by incorporating high-resolution logging tools such as Nuclear Magnetic Resonance (NMR) tools, Array Induction Imager Tools (AIT), Full-bore Formation Micro-Imager (FMI) tools, and dielectric tools.

NMR tools have shown promising results in estimating irreducible water saturation caused by clay and smaller grain size and assessing residual oil saturation directly from the log. This significantly contributes to the evaluation of LRP zones, as the relaxation time T₂ can provide some insights into the amount and type of oil present. However, an NMR tool has certain limitations as it only examines the flushed zone with a limited depth of investigation of 1.5 inches (3.81 cm). Thus, it may not provide a comprehensive understanding of the subsurface conditions. Therefore, employing other tools (or techniques) in conjunction with NMR may be necessary to obtain a more accurate assessment of LRP zones. The AIT and FMI tools have proven beneficial in analyzing thin beds, which can impact the identification of LRP zones.

A dielectric tool can provide a resistivity-independent saturation profile, which can assist in estimating water saturation in LRP zones. However, the effectiveness of the dielectric tool depends on the invasion depth being shallow. When the invasion depth is significant, the dielectric measurements can be affected by factors such as the presence of conductive minerals and mud-cake formation, leading to inaccurate estimates of water saturation. On the other hand, processing procedures can aid in measuring shaliness, porosity, and water saturation in thinner layers (typically within a range of 2 inches) and improving the resolution of the log entries for better calculations of saturation and reserves. Table 1 summarizes the characteristics and features of the current tools and techniques and limitations in detecting LRP zones.

TABLE 1
Resolution, contribution, and limitations of different logging tools

| | Vertical | | Depth of | | |
|---|---|---|---|---|---|
| Tool | Resolution | | Investigation | Contribution | Limitations |
| Conventional | 2 | feet | 8 inches-64 | Average | Lack of vertical |
| Resistivity logs | | | inches | resistivity | and horizontal |
| | | | | estimation | resolution/ |
| | | | | | Inability to |
| | | | | | differentiate |
| | | | | | the LRP zone |
| NMR (Nuclear | 6 | inches | 1.5 inches-4 | Irreducible water | Successful in |
| Magnetic | | | inches | saturation, | flushed zones/ |
| Resonance) | | | | residual oil | Shallow depth |
| | | | | saturation | of penetration |
| AIT (Array | 1 feet-4 feet | | 10 inches-90 | High-resolution | Inability to |
| Induction | | | inches | resistivity | distinguish |
| Imager Tool) | | | | estimation | LRP zones |
| FMI (Full-bore | 0.2 | inch | — | Identification of | Superficial values |
| Formation | | | | thin bedding with | around the wall |
| Micro-Image) | | | | high-resolution | of the borehole. |
| Tool | | | | resistivity values | No direct |
| | | | | | identification |
| | | | | | of LRP zone |
| Dielectric Tool | 1 | inch | 1 inch-4 inches | Resistivity- | Invasion/shallow |
| | | | | independent | depth of |
| | | | | saturation profile | investigation |

Each of the aforementioned tools suffers from one or more drawbacks hindering their adoption. Accordingly, it is one object of the present disclosure to provide methods and systems for implementing a geophysical method called Spectral Induced Polarization (SIP) for measuring the complex conductivity, for example across a wide frequency range (1 mHz-10,000 Hz), that facilitates the detection of the LRP zones.

U.S. Pat. No. 10,267,943B2 describes the use of the SIP method for measuring two formations in a subterranean zone over a frequency range of 0.01 Hz to 1 kHz.

U.S. Pat. No. 9,880,312B2 describes the use of the SIP method for measuring complex impedance over a frequency range of 1 mHz to 20 KHz.

U.S. Pat. No. 7,863,901B2 discloses the use of the SIP method measuring and fitting the complex impedance with an induced polarization model.

However, none of the prior art references disclose detecting LRP zones by SIP.

### SUMMARY

In an exemplary embodiment, a method of LRP characterization is disclosed. The method includes obtaining spectral induced polarization (SIP) measurements of a volume of a formation at a plurality of frequencies to determine a frequency-dependent complex (FDC) impedance value of a matrix material in the volume of the formation. The method further includes determining whether the volume is a low resistivity pay (LRP) zone with a formation resistivity index≤2, by analyzing the FDC impedance value of the matrix material and identifying the volume of the subsurface formation as the LRP zone when the FDC impedance value exhibits a dispersion at increasing frequencies. The FDC impedance value is substantially constant before the dispersion and increases by at least one order of magnitude over one order of magnitude of the increasing frequencies.

In some embodiments, the method includes obtaining the SIP measurements of the volume of the subsurface formation using an SIP device that includes an SIP column including a plurality of potential electrodes arranged along a longitudinal direction of the SIP column; and two of current electrodes positioned on opposing ends of the SIP column.

In some embodiments, obtaining the SIP measurements includes obtaining a first set of SIP measurements between two potential electrodes of the plurality of potential electrodes and obtaining a second set of SIP measurements between another two potential electrodes of the plurality of potential electrodes.

In some embodiments, the SIP device is a portable SIP unit.

In some embodiments, the method further includes placing potential electrodes and current electrodes adjacent to the volume of the formation, injecting an alternating electrical current into the formation through the current electrodes at a first frequency, and measuring a first set of data via the potential electrodes at the first frequency.

In some embodiments, the first set of data is at least one selected from the group consisting of a voltage distribution, a phase shift, and an impedance distribution.

In some embodiments, the electrical current has a current waveform of sinusoidal frequencies.

In some embodiments, the potential and current electrodes are placed at intervals along a borehole adjacent to the volume of the subsurface formation or on a ground surface above the volume of the subsurface formation.

In some embodiments, injecting the electrical current and measuring the set of data are executed simultaneously.

In some embodiments, the method further includes plotting the FDC impedance value against the plurality of frequencies and determining whether the FDC impedance value exhibits the dispersion at the increasing frequencies based on the plotting.

In some embodiments, the dispersion is exhibited above 50 Hz at increasing frequencies.

In some embodiments, the dispersion is exhibited between 50 Hz and 1,000 Hz at increasing frequencies.

In some embodiments, the plurality of frequencies includes a range sweep over 0.01-10,000 Hz.

In some embodiments, the plurality of frequencies includes a range sweep over 1-5,000 Hz.

In some embodiments, the plurality of frequencies includes no more than ten discrete frequencies between 0.01 Hz and 10,000 Hz.

In some embodiments, the plurality of frequencies includes no more than ten discrete frequencies between 1 Hz and 5,000 Hz.

In some embodiments, the method further includes analyzing a frequency-dependent real conductivity value of the matrix material in the volume of the subsurface formation and identifying the volume of the subsurface formation as the LRP zone when the frequency-dependent real conductivity value exhibits a dispersion effect at the increasing frequencies.

In some embodiments, the frequency-dependent real conductivity value decreases to zero as a result of the dispersion effect.

In some embodiments, the method further includes identifying the volume of the subsurface formation as the LRP zone when the FDC impedance value is substantially constant when the increasing frequencies are smaller than 10 Hz and increases by at least one order of magnitude between 10 Hz and 1,000 Hz.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 depicts a method for formation characterization according to certain embodiments;

FIG. 2A and FIG. 2B show scanning electron microscopic (SEM) images of 0.3-0.5 mm silica gel, according to certain embodiments;

FIG. 3 illustrates an embodiment of a column modified for Spectral Induced Polarization (SIP) measurements;

FIG. 4A shows a plot illustrating impedance readings over a frequency range of 0.01 Hz to 10,000 Hz for 0.3-0.5 mm silica gel saturated with brine, mixed saturation of brine-oil, and mixed-saturated with the addition of 10% pyrite on a potential electrode pair including a first potential electrode and a fifth potential electrode, according to certain embodiments;

FIG. 4B shows a plot illustrating impedance readings over a frequency range of 0.01 Hz to 10,000 Hz for 0.3-0.5 mm silica gel saturated with brine, mixed saturation of brine-oil, and mixed-saturated with the addition of 10% pyrite on another potential electrode pair including a second potential electrode and a fourth potential electrode, according to certain embodiments;

FIG. 4C shows a plot illustrating impedance readings over a frequency range of 0.01 Hz to 10,000 Hz for 0.3-0.5 mm silica gel saturated with brine, mixed saturation of brine-oil, and mixed-saturated with the addition of 10% pyrite on yet another potential electrode pair including the second potential electrode and a third potential electrode, according to certain embodiments;

FIG. 5A shows a plot illustrating real conductivity over a frequency range of 0.01 Hz to 10,000 Hz for 0.3-0.5 mm silica gel saturated with brine, oil, and oil saturated with the addition of 10% pyrite on a potential electrode pair, including the first potential electrode and the fifth potential electrode, according to certain embodiments;

FIG. 5B shows a plot illustrating real conductivity over a frequency range of 0.01 Hz to 10,000 Hz for 0.3-0.5 mm silica gel saturated with brine, oil, and oil saturated with the addition of 10% pyrite on another potential electrode pair including the second potential electrode and the fourth potential electrode, according to certain embodiments;

FIG. 5C shows a plot illustrating real conductivity over a frequency range of 0.01 Hz to 10,000 Hz for 0.3-0.5 mm silica gel saturated with brine, oil, and oil saturated with the addition of 10% pyrite on yet another potential electrode pair including the second potential electrode and the third potential electrode, according to certain embodiments;

FIG. 6A shows a schematic model representing porous saturated media of silica gel saturated with brine, according to certain embodiments;

FIG. 6B shows a schematic model representing the porous saturated media of silica gel with mixed saturation, where brine is present in the micro-pores while oil fills the macro-pores, according to certain embodiments;

FIG. 6C shows a schematic model representing the porous saturated media of silica gel with mixed saturation (where brine is present in the micro-pores while oil fills the macro-pores) and 10% pyrite, according to certain embodiments;

FIG. 7A shows a plot illustrating impedance signals over for 0.3-0.5 mm and 1-3 mm silica gel brine-oil saturated with the addition of 10% pyrite on the first potential electrode, the second potential electrode, the third potential electrode, the fourth potential electrode, and the fifth potential electrode, according to certain embodiments; and

FIG. 7B shows a plot illustrating real conductivity signals over 0.3-0.5 mm and 1-3 mm silica gel brine-oil saturated with the addition of 10% pyrite on the first potential electrode, the second potential electrode, the third potential electrode, the fourth potential electrode, and the fifth potential electrode, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

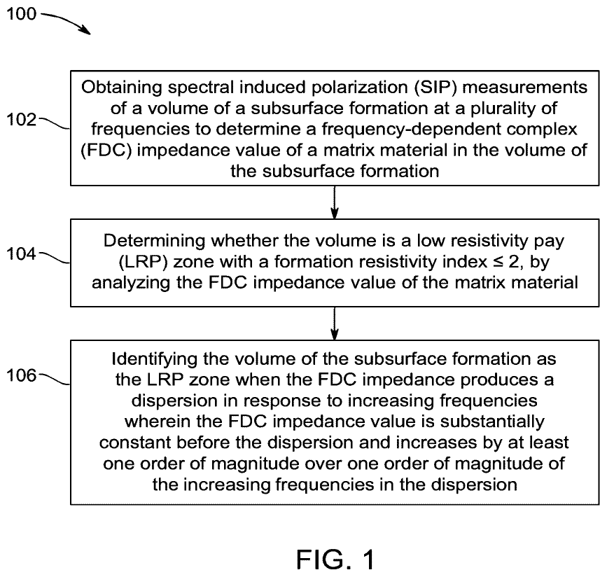

Aspects of the present disclosure are directed to a method for detecting, analyzing and characterizing low resistivity pay (LRP) zones using spectral induced polarization (SIP). The method focuses on complex conductivity measurements across a frequency spectrum, from 1 mHz to 10,000 Hz. The method can be employed to address the challenge of LRP zones and can be potentially extended to a new well-logging tool for improved characterization and development of LRP reservoirs. The manner in which subsurface formation characterization is performed is described hereinafter. Referring to FIG. 1, a method 100 for subsurface formation characterization is described. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes obtaining SIP measurements of a volume of a subsurface formation at a plurality of frequencies to determine a frequency-dependent complex (FDC) impedance value of a matrix material in the volume of the subsurface formation.

At step 104, the method 100 includes determining whether the volume of the subsurface formation is an LRP zone with a formation resistivity index≤2. In an implementation, the determination of whether the volume of the subsurface formation is the LRP zone with the formation resistivity index≤2 is made by analyzing the FDC impedance value of the matrix material.

At step 106, the method 100 includes identifying the volume of the subsurface formation as the LRP zone when the FDC impedance value exhibits a dispersion in response to increasing frequencies. The FDC impedance value is substantially constant before the dispersion and increases by at least one order of magnitude over one order of magnitude of the increasing frequencies in the dispersion. The FDC impedance value is plotted against the plurality of frequencies, and it is determined whether the FDC impedance value exhibits the dispersion at or in response to the increasing frequencies based on the plotting. In an example, the plurality of frequencies includes a range sweep over 0.01 Hz to 10,000 Hz, preferably 1 Hz to 5,000 Hz, preferably 5 Hz to 1,000 Hz, preferably 8 Hz to 500 Hz. In some examples, the plurality of frequencies includes no more than ten discrete frequencies between 0.01 Hz and 10,000 Hz, preferably between 1 Hz and 5,000 Hz, preferably between 5 Hz and 1,000 Hz, preferably between 8 Hz and 500 Hz. In an example, the dispersion is exhibited above 50 Hz at the increasing frequencies. In some examples, the dispersion is exhibited between 1 Hz and 5,000 Hz, or between 5 Hz and 1,000 Hz, or between 10 Hz and 500 Hz, or between 50 Hz and 100 Hz, at the increasing frequencies.

According to an implementation, a frequency-dependent real conductivity value of the matrix material is analyzed in the volume of the subsurface formation. Further, the volume of the subsurface formation is identified as the LRP zone when the frequency-dependent real conductivity value exhibits a dispersion effect at increasing frequencies. The frequency-dependent real conductivity value decreases to zero as a result of the dispersion effect. In some implementations, the volume of the subsurface formation is identified as the LRP zone when the FDC impedance value is substantially constant when the increasing frequencies are smaller than 10 Hz and increases by at least one order of magnitude between 10 Hz and 1,000 Hz.

In an implementation, the SIP measurements of the volume of the subsurface formation are obtained using an SIP device. The SIP device is a portable SIP unit. The SIP device includes an SIP column including a plurality of potential electrodes arranged along a longitudinal direction of the SIP column. The SIP device also includes two current electrodes positioned on opposing ends of the SIP column.

According to an implementation, the SIP measurements are obtained based on obtaining a first set of SIP measurement between two of the plurality of potential electrodes and obtaining a second set of SIP measurements between another two of the plurality of potential electrodes.

In an implementation, the potential electrodes and the current electrodes are placed adjacent to the volume of the subsurface formation. In the experimental process, an alternating electrical current is injected into the subsurface formation through specific electrodes, covering a wide frequency range. The SIP technique measures both the phase shifts and amplitudes of injected (Iₚ) and measured (Vₚ) signal, providing valuable insights into the electrical properties of the subsurface materials. The measurement is thus a complex impedance with magnitude Vₚ/Iₚ and phase (φ) and after the real and imaginary apparent resistivity or conductivity is calculated.

In some implementations, the potential electrodes and the current electrodes are placed at intervals along a borehole adjacent to the volume of the subsurface formation or on a ground surface to characterize the subsurface formation. The injection of the first electrical current and the measurement of the first set of data are executed simultaneously.

### Examples

The following examples describe and demonstrate exemplary embodiments as described herein. The examples are provided solely for the purpose of illustration and are not to be construed as limitations of the present disclosure, as many variations thereof are possible without departing from the spirit and scope of the present disclosure.

### Examples and Experiments

### Experimental Data and Analysis

An experiment was conducted using different samples of silica gel. The samples had a grain size ranging from 0.3 to 0.5 mm and micro-pores having a size of 150 Å along with 1-3 mm grain size and micro-pores size of 70 Å, both characterized by well-controlled micro-porosity and macro-porosity fractions (total porosity of 50%). The silica gel used in the experiment was a well-controlled dual porosity silica gel. The micro-pores were found within the grains, while the macro-pores were observed between the grains.

During the experiment, two types of saturations were tested for both grain size silica gel samples, including fully brine saturation and mixed partial saturation, where brine saturates micro-pores while oil saturates macro-pores. The brine used in the experiment had a potassium chloride (KCl) concentration of 10 wt. %, resulting in a brine resistivity of 0.07 Ohm·m. The oil used in the experiment was Arabian Light crude oil.

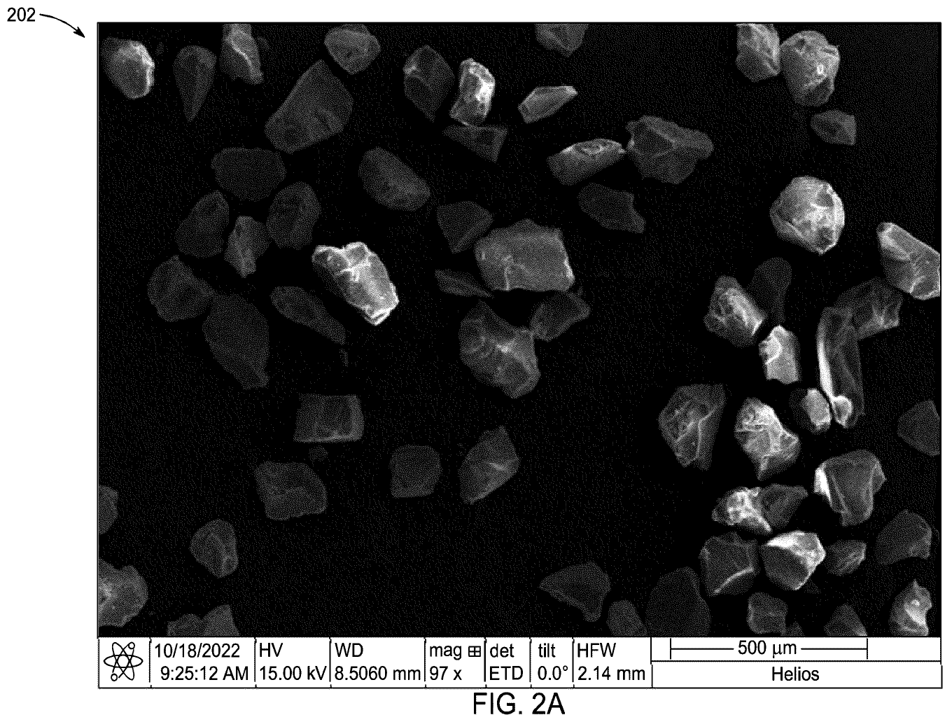

The full brine-saturated silica gel was placed on a filter paper to drain the macro-pores, while the brine was retained in the micro-pores to achieve mixed partial saturation. After that, oil was added to saturate the macro-pores, resulting in a silica gel sample with mixed fluid saturation. FIG. 2A and FIG. 2B show scanning electron microscopic images of 0.3-0.5 mm silica gel. The electron microscopic images are represented by reference numerals “202” and “204” in FIG. 2A and FIG. 2B, respectively.

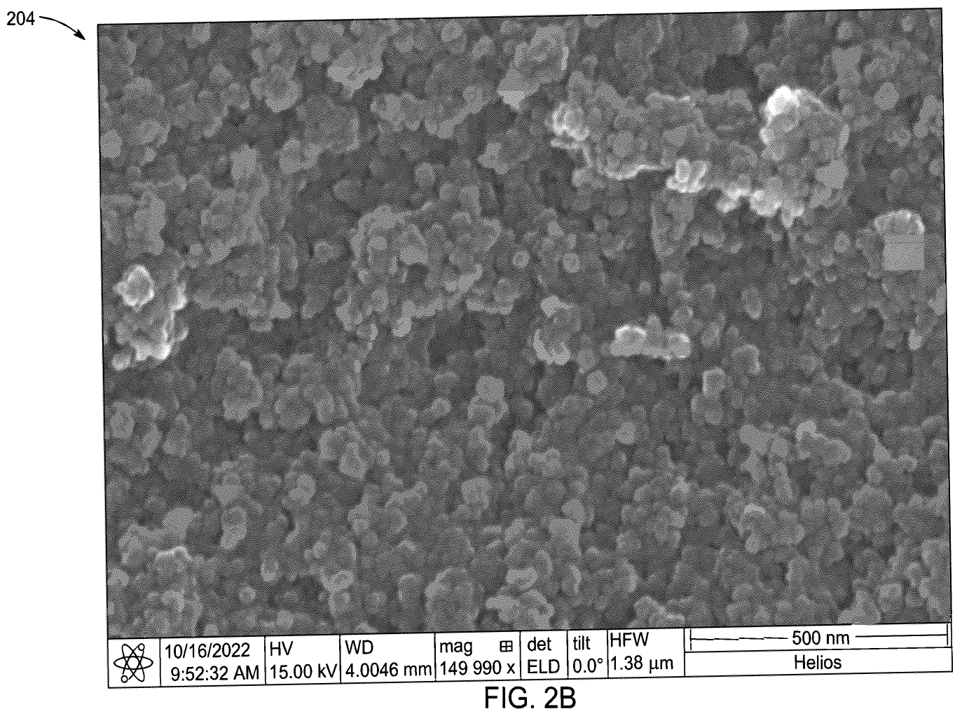

Referring to FIG. 3, an amended column 300 was connected to an SIP instrument 301 The SIP column 300 is a 190 mm long acrylic column. The SIP column 300 includes five potential electrodes including a first potential electrode 304, a second potential electrode 306, a third potential electrode 308, a fourth potential electrode 310, and a fifth potential electrode 312. The potential electrodes 304-312 are arranged along a longitudinal direction of the SIP column 300. The potential electrodes 304-312 can be symmetrically placed along the body of the SIP column 300. The potential electrodes 304-312 are placed at the outer edge of the SIP column body away from the current pathway to minimize any possible polarization effects.

The SIP column 300 further includes two current electrodes, including a first current electrode 314 and a second current electrode 316. The first current electrode 314 can be a positive current electrode and the second current electrode 316 can be a negative current electrode. As shown in FIG. 3, covers caps are closed via an O-shaped ring 318 to avoid leakages, same for the second current electrode 316 which is sealed via another O-shaped ring 320. Measurements can be taken in different scales depending the selected pairs of electrodes. In the current work, 3 scales were selected; short 326 utilizing electrodes 306 and 308, medium 324 utilizing electrodes 306 and 310, and wide 322 utilizing electrodes 304 and 312. All electrodes were made of silver/silver chloride (Ag—AgCl). Internal diameter of column was 23 mm.

In the experimental setup, the silica gel sample was packed inside the SIP column 300 shown in FIG. 3. A final test was performed for each grain-size silica gel by adding 10% (by solid volume) of pure pyrite to the mixed brine-oil saturated sample. The pyrite particles had a similar grain size to the silica gel (0.3-0.5 mm and 1-3 mm). SIP measurements were taken at a frequency range of 0.01 Hz to 10 kHz. Specifically, seven measurements were collected for each logarithmic decade. The SIP measurements were collected between the first potential electrode 304 and the fifth potential electrode 312, between the second potential electrode 306 and the fourth potential electrode 310, and between the second potential electrode 306 and the third potential electrode 308. Prior to collecting the SIP measurements, the electrode contact resistance was assessed for all electrodes to identify and address any issues related to contact resistance.

In SIP, the real and imaginary components of the complex conductivity (σ*) or resistivity (ρ*) are calculated based on the measured electrical response of the subsurface porous media over a range of frequencies. The complex conductivity (σ*) may be mathematically represented as:

$${σ}^{*} = \vert σ ( ω ) \vert {e}^{i φ ( ω )} = {σ}^{′} ( ω ) + i {σ}^{″} ( ω ) \qquad ( 1 )$$

where, i²=−1, ω=2πf represents the angular frequency, (|σ(ω)|) represents the magnitude of conductivity, and (φ) represents the phase shift between the injected current and the measured voltage. Both |σ(φ)| and φ are the actual measured terms during SIP measurement, while the real (σ′) and imaginary (σ″) components may be calculated using the following equations:

$$φ ( ω ) = {tan}^{- 1} \frac{σ″ ( ω )}{σ′ ( ω )} \qquad ( 2 )$$

$$\vert σ \vert = \sqrt{{σ}^{′2} + {σ}^{″2}} \qquad ( 3 )$$

The real conductivity is related to the electrical conductivity of the subsurface porous media, which is influenced by factors such as porosity, mineralogy, and fluid content. On the other hand, the imaginary conductivity is related to the induced polarization effect, which is influenced by factors such as the surface area of mineral grains, the thickness of the electrical double layer thickness, and the presence of conductive minerals. Both the real and imaginary components can be plotted as a function of frequency to obtain a spectral response, which can be used to infer the porous media properties.

The SIP measurements on the silica gel were carried out using a portable SIP device by Ontash & Ermac®. Phase shift (φ), conductivity magnitude (|σ|), and impedance were measured in the frequency range of 0.01 Hz to 10,000 Hz. The PSIP device includes 24 potential channels and four current injectors (stimuli). The SIP device has the capability to perform up to four separate tests simultaneously. This enables testing for repeatability and shortening of the experimental period by running multiple tests concurrently. It should be noted that the SIP device used herein is just one of the available commercially examples. In other examples, the experimental setup includes any number of potential electrodes arranged in any spacing or pattern, depending on design needs.

Table 2 illustrates the setup for the test input. Various resistors were tested to optimize the signal-to-noise ratio measurement and prevent saturation effects that may occur at higher resistances. By selecting appropriate resistor values, SIP measurements can provide a more accurate and detailed characterization of the electrical properties of the tested material.

TABLE 2
SIP device configuration settings
Sweep Settings

| | | | Current resistor |
|---|---|---|---|
| Frequency (Hz) | No. of steps | Amplitude (V) | (Ohms) |
| 0.01-10,000 | 41 | 5 | 10,000 |

Processing Settings

| | | | Integration |
|---|---|---|---|
| Settle time (s) | Settle cycles | Integration time | cycles |
| 1 | 1 | 5 | 5 |

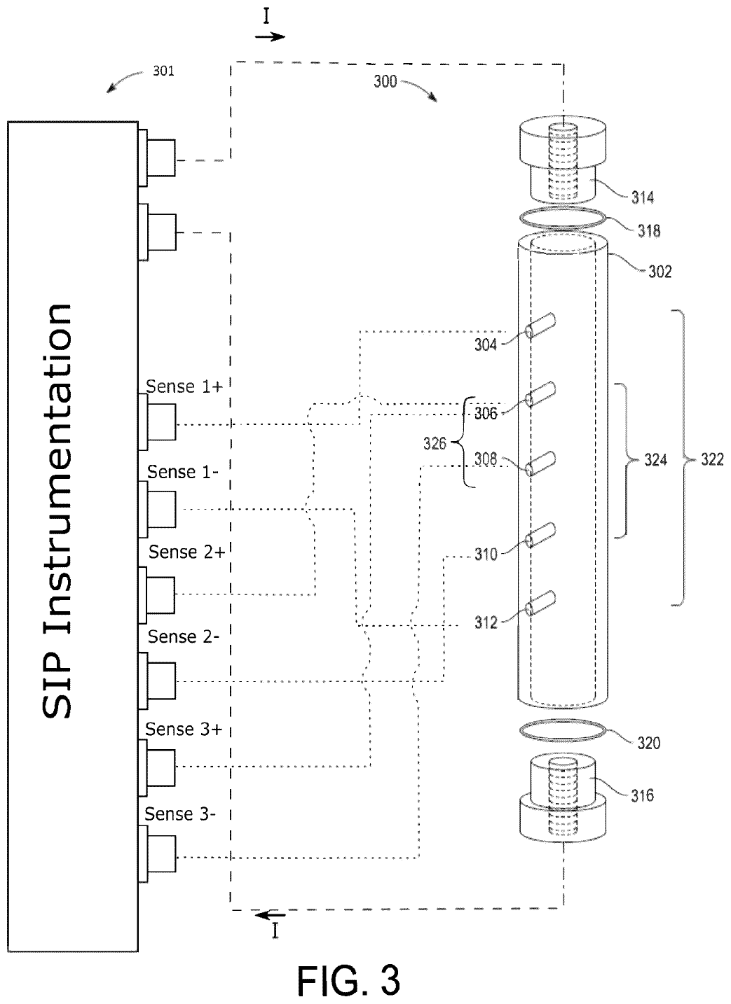

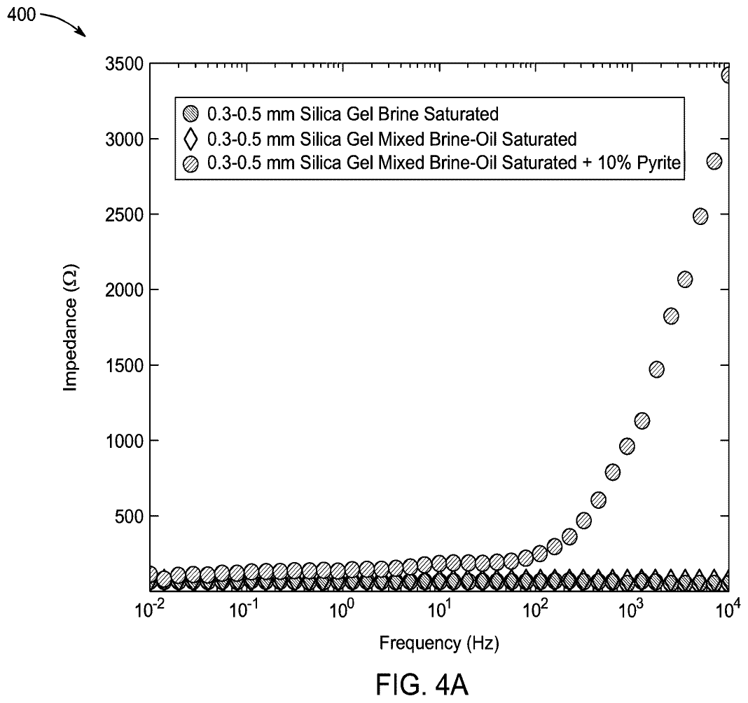

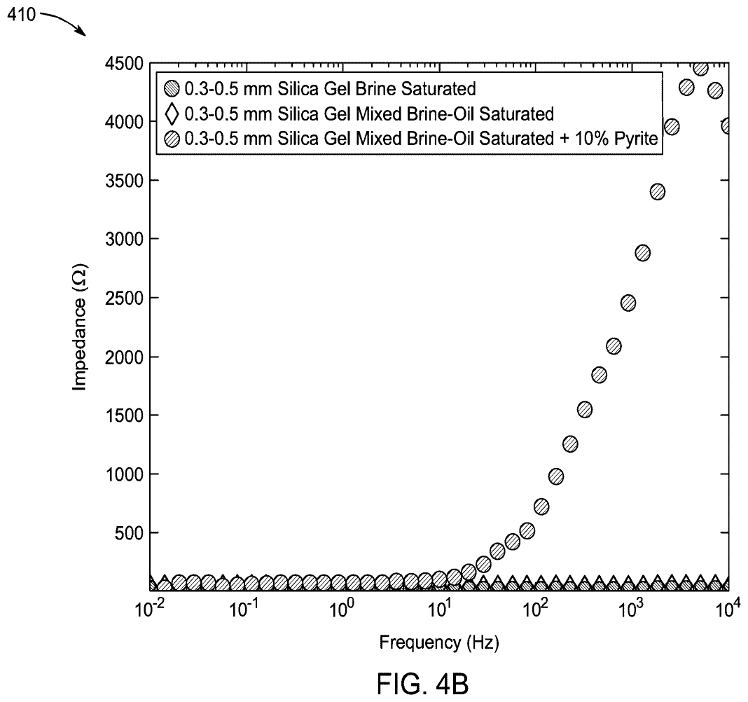

FIG. 4A shows a plot 400 illustrating impedance readings over a frequency range of 0.01 Hz to 10,000 Hz for 0.3-0.5 mm silica gel saturated with brine, mixed saturation of brine-oil, and mixed-saturated with the addition of 10% pyrite on a potential electrode pair including the first potential electrode 304 and the fifth potential electrode 312; FIG. 4B shows a plot 410 illustrating impedance readings over a frequency range of 0.01 Hz to 10,000 Hz for 0.3-0.5 mm silica gel saturated with brine, mixed saturation of brine-oil, and mixed-saturated with the addition of 10% pyrite on another potential electrode pair including the second potential electrode 306 and the fourth potential electrode 310; and FIG. 4C shows a plot 420 illustrating impedance readings over a frequency range of 0.01 Hz to 10,000 Hz for 0.3-0.5 mm silica gel saturated with brine, mixed saturation of brine-oil, and mixed-saturated with the addition of 10% pyrite on yet another potential electrode pair including the second potential electrode 306 and the third potential electrode 308.

As shown in FIG. 4A, FIG. 4B, and FIG. 4C, the silica gel fully saturated with brine exhibits an extremely low impedance within a range of 4 Ohms to 9 Ohms and remains constant across a wide frequency range (0.01 mHz-10 kHz). In the case of the silica gel samples with mixed brine-oil saturation, the impedance maintains a consistent behavior at low values of approximately 75 Ohms across all frequencies. However, when pyrite, which is uniformly distributed throughout the silica gel sample, is added, the impedance increases and disperses. Consider FIG. 4A for example, the impedance disperses at frequencies starting from 100 Hz, reaching a value of 3500 Ohms at 10 kHz. This increase in impedance is indicative of the presence of oil. That is, the impedance is substantially constant (e.g., 4 Ohms to 9 Ohms) before the dispersion and increases by at least one order of magnitude (e.g., two orders of magnitude from 9 Ohms to 1000 Ohms) over one order of magnitude of the increasing frequencies (e.g., from 100 Hz to 1,000 Hz). The measurements conducted through various channels consistently demonstrate similar magnitudes and dispersion for the mixed-saturated silica gel samples containing 10% pyrite.

Therefore, an LRP zone can be identified when the FDC impedance value is substantially constant when the increasing frequencies are smaller than a certain value, X and increases by at least one order of magnitude as the increasing frequencies change from X to 10X. X can be any value between 1 Hz and 1,000 Hz, or between 5 Hz and 500 Hz, or between 10 Hz and 100 Hz, or about 50 Hz.

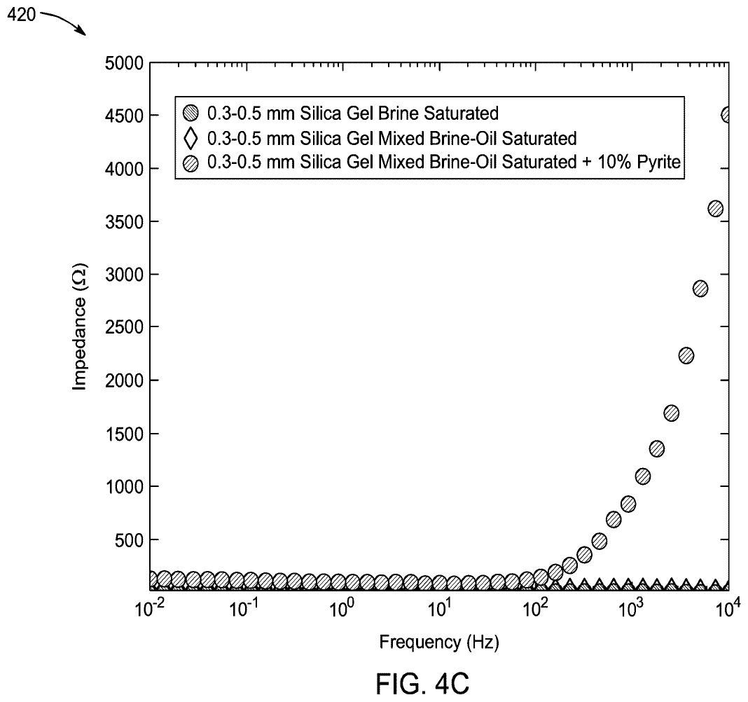

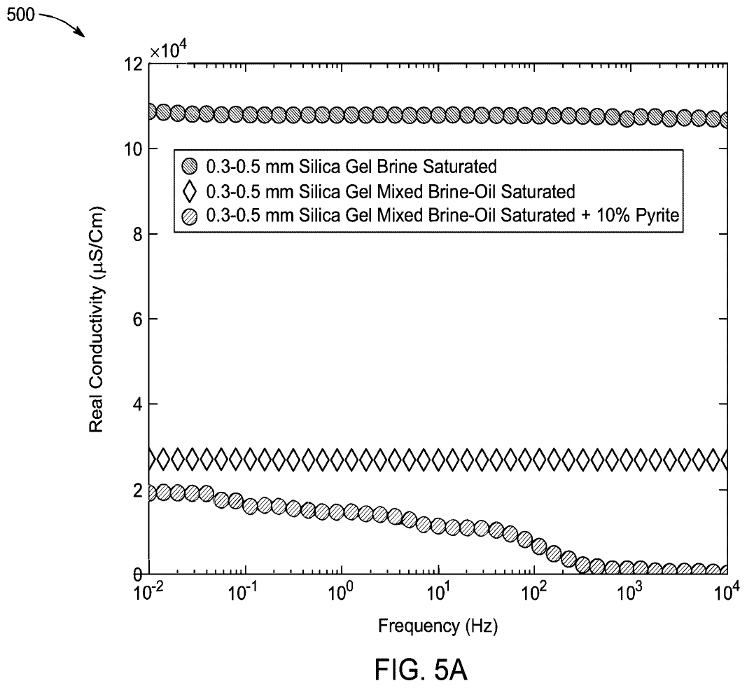

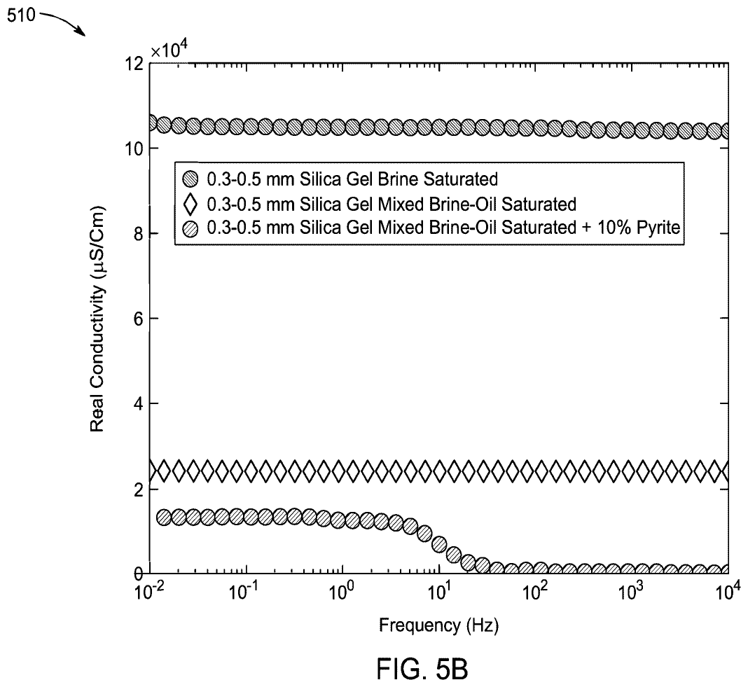

FIG. 5A shows a plot 500 illustrating real conductivity over a frequency range of 0.01 Hz to 10,000 Hz for 0.3-0.5 mm silica gel saturated with brine, oil, and oil saturated with the addition of 10% pyrite on a potential electrode pair including the first potential electrode 304 and the fifth potential electrode 312; FIG. 5B shows a plot 510 illustrating real conductivity over a frequency range of 0.01 Hz to 10,000 Hz for 0.3-0.5 mm silica gel saturated with brine, oil, and oil saturated with the addition of 10% pyrite on another potential electrode pair including the second potential electrode 306 and the fourth potential electrode 310; and FIG. 5C shows a plot 520 illustrating real conductivity over a frequency range of 0.01 Hz to 10,000 Hz for 0.3-0.5 mm silica gel saturated with brine, oil, and oil saturated with the addition of 10% pyrite on yet another potential electrode pair including the second potential electrode 306 and the third potential electrode 308.

As illustrated in FIG. 5A, FIG. 5B, and FIG. 5C, the real conductivity of the silica gel mixtures exhibits a consistent behavior with high values above 11-10⁴ μS/cm. Similarly, silica gel samples with mixed brine-oil saturation exhibit a value of about 3-10⁴ μS/cm with the same behavior. When pyrite was added, the real conductivity of the silica gel mixtures remained consistent at lower frequencies. However, at higher frequencies, for example around 50 Hz, the real conductivity decreased to almost zero values. This decrease implies the presence of oil, which is highly resistive.

It should be noted that the frequency sweep is continuous in the examples of FIGS. 4A-4C and 5A-5C. In other examples, a plurality of discrete frequencies may be used instead, such as no more than ten discrete frequencies between 0.01 Hz and 10,000 Hz, preferably between 1 Hz and 5,000 Hz, preferably between 5 Hz and 1,000 Hz, preferably between 8 Hz and 500 Hz. In one example, discrete frequencies such as 1 Hz, 5 Hz, 10 Hz, 50 Hz, 100 Hz and 1,000 Hz can be chosen, and the dispersion can still be observed, for example by a noticeable increase in impedance or a noticeable decrease in real conductivity, instead of substantially constant values.

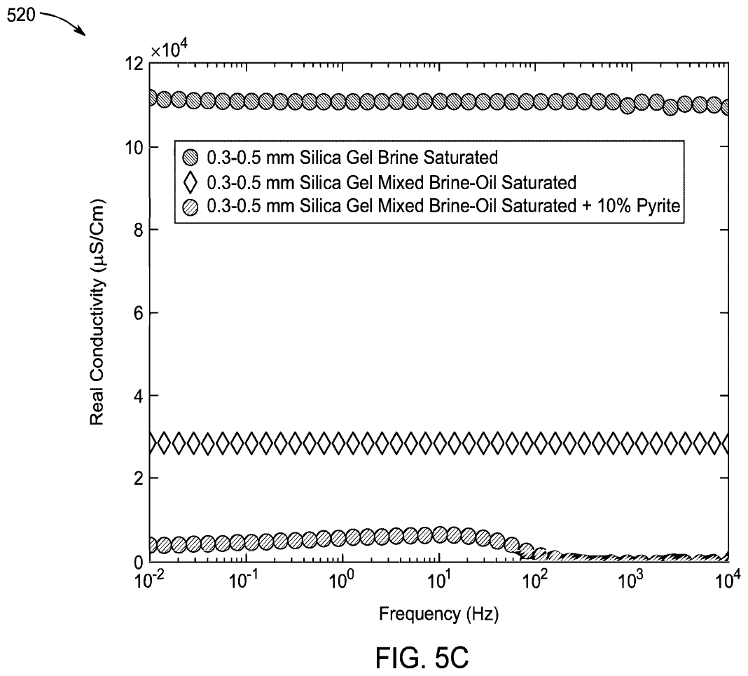

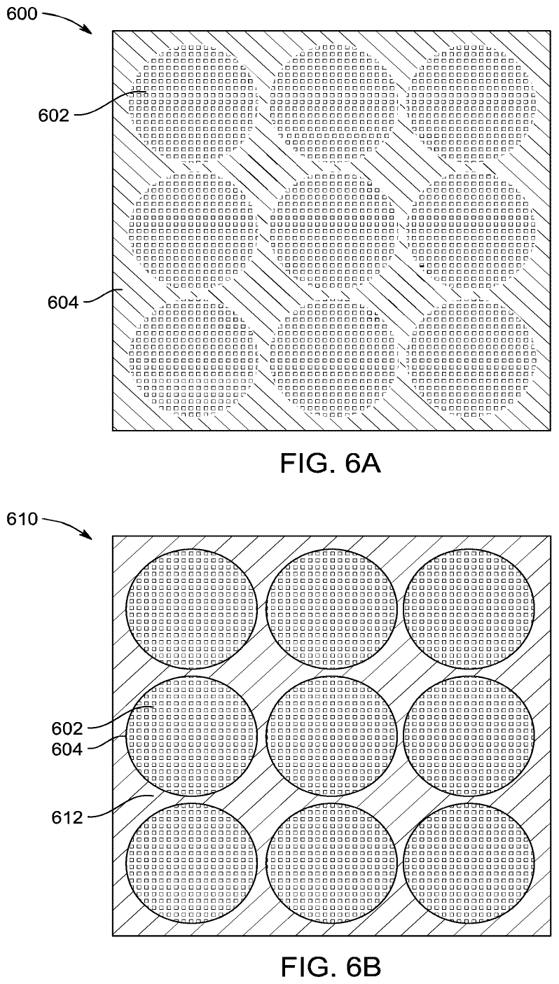

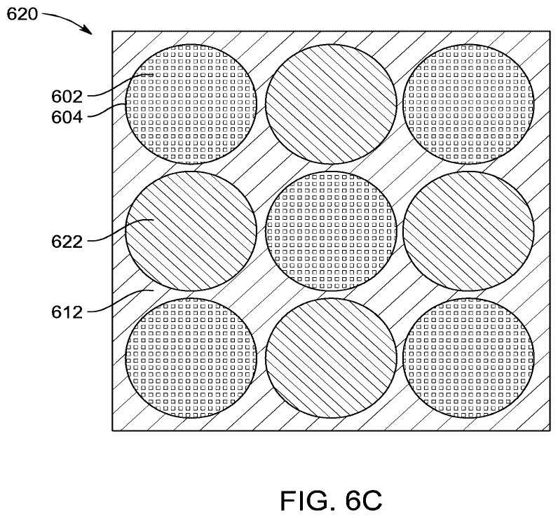

FIG. 6A shows a schematic model 600 representing the porous saturated media of silica gel saturated with brine, according to certain embodiments. In FIG. 6A, the reference numeral “602” represents silica gel grains and the reference numeral “604” represents brine fill. When silica gel is saturated with brine, the impedance values are extremely low, and the conductivity values are very high. This is primarily due to the brine that fills the pores, thus providing an easy path for the current flow. The continuous phase created by the micro-pores of the silica gel sample further contributes to the electrical charge flow.

FIG. 6B shows a schematic model 610 representing the porous saturated media of silica gel with mixed saturation, where brine is present in the micro-pores while oil fills the macro-pores, according to certain embodiments. In FIG. 6B, the reference numeral “602” represents silica gel grains, the reference numeral “604” represents brine fill, and the reference numeral “612” represents the oil fill. Similar to the low impedance observed in the silica gel with mixed brine-oil saturation, the fine grains in FIG. 6B are associated with high levels of irreducible water saturation and abundant micro-porosity. The silica gel sample still exhibits a continuous phase and maintains low and constant impedance values across a range of frequencies.

FIG. 6C shows a schematic model 620 representing the porous saturated media of silica gel with mixed saturation (where brine is present in the micro-pores while oil fills the macro-pores) and 10% pyrite, according to certain embodiments. In FIG. 6C, the reference numeral “602” represents silica gel grains, the reference numeral “604” represents brine fill, the reference numeral “612” represents the oil fill, and the reference numeral “622” represents pyrite grains. When pyrite is added to a matrix containing oil and water, it can preferentially coat the rock surface and make it more hydrophobic, causing a discontinuity in the electrical conductivity of the sample. This is due to the wettability of pyrite, which refers to how well a liquid spreads out or wets the pyrite surface. Since pyrite is known to be hydrophobic (i.e., it repels water), adding pyrite to the silica gel sample enhances the visibility of oil, particularly at higher frequencies, as indicated by the dispersion signature.

The high concentration of ions in brine leads to enhanced conductivity due to a greater thickness of the electrical double layer (EDL). However, when oil is added, where the ionic concentration is low, a decrease in conductivity can be observed. This is because the thickness of the EDL decreases, resulting in less contribution to the current flow.

Despite the change in the EDL at the solid-fluid interface, a continuous phase still connects the grains, as depicted in FIG. 6B. This implies that the changes in the EDL have little effect on the water-wet substance. However, when a hydrophobic element like pyrite is introduced, it creates a discontinuity in electrical conductivity that affects both the EDL and the Maxwell-Wagner. This leads to a decrease in conductivity values and ultimately results in dispersion at higher frequencies.

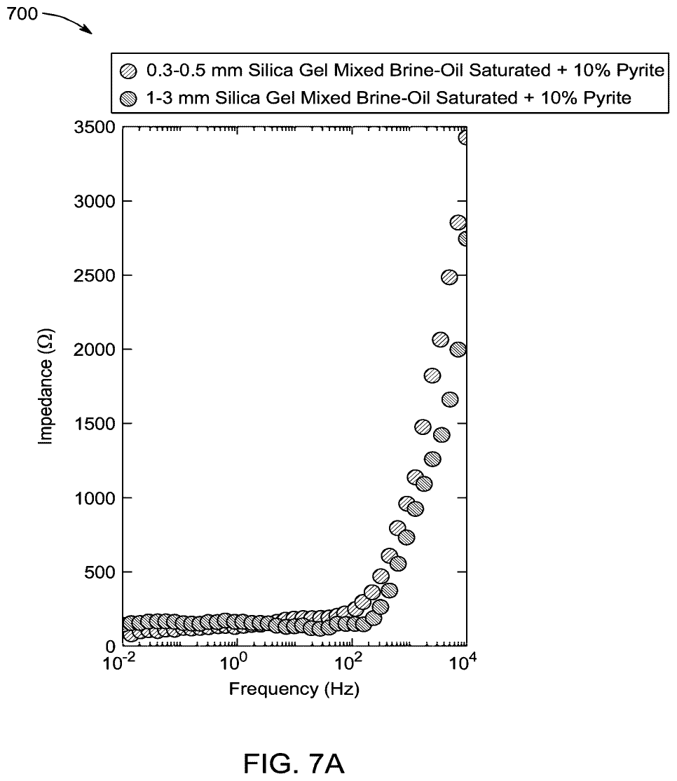

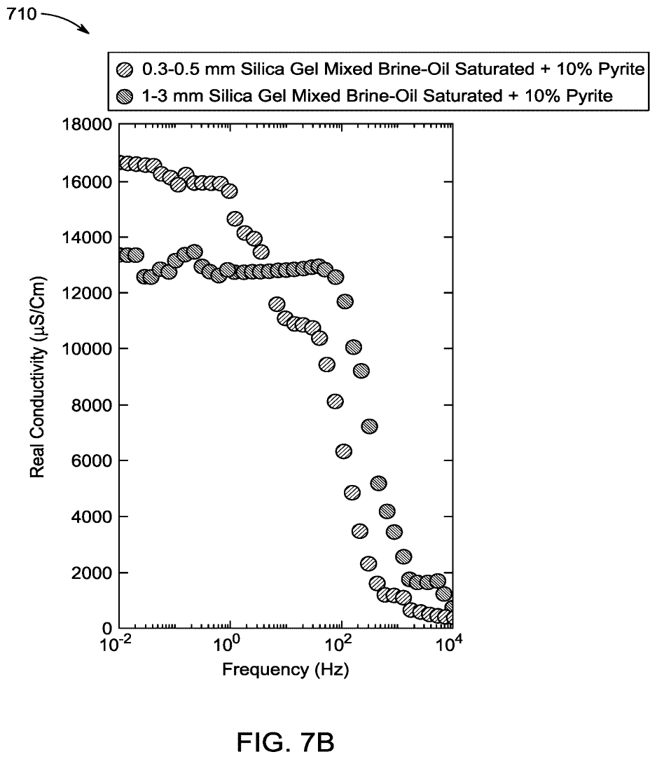

To validate the reliability of impedance and conductivity, the silica gel sample was examined using particles of different sizes (for example, 1-3 mm). FIG. 7A shows a plot 700 illustrating impedance signals over for 0.3-0.5 mm and 1-3 mm silica gel brine-oil saturated with the addition of 10% pyrite, on the first potential electrode 304, the second potential electrode 306, the third potential electrode 308, the fourth potential electrode 310, and the fifth potential electrode 312.

FIG. 7B shows a plot 710 illustrating real conductivity signals over for 0.3-0.5 mm and 1-3 mm silica gel brine-oil saturated with the addition of 10% pyrite, on the first potential electrode 304, the second potential electrode 306, the third potential electrode 308, the fourth potential electrode 310, and the fifth potential electrode 312.

Based on the observations from FIG. 7A and FIG. 7B, the presence of oil can be identified by the dispersion effect observed at higher frequencies. The trend remains the same, but the scales by which the influence of the surface area is accounted for differ. Smaller grains exhibit a larger surface area, resulting in higher conductivity values at lower frequencies. However, in the frequency range from 100 Hz to 10,000 Hz, the impedance values increase to higher levels in the 0.3-0.5 mm silica gel sample with pyrite, reaching around 3500 Ohms, compared to 1-3 mm silica gel sample with mixed pyrite saturation, which reaches approximately 2800 Ohms. Similarly, for conductivities, the fine grains (0.3-0.5 mm) exhibit a greater decrease compared to the coarser grains (1-3 mm). This can be explained by the increased surface area of pyrite surrounded by oil, which creates more discontinuities in electrical conductivity. As a result, a more resistive component (phase) related to oil is observed at higher frequencies.

The results obtained from low-frequency (similar to the Direct Current-DC resistivity method) measurements demonstrated the low resistivity typically observed in LRP zones. When using higher-frequency SIP measurements, the impedance and conductivity values revealed the presence of resistive oil. Due to the wettability impact of the silica gel, fully mixed brine-oil saturated samples do not exhibit a significant dispersion response. However, by trying to resemble an LRP zone in the reservoir by adding pyrite, the ability to detect oil becomes more apparent. The dispersion observed at higher frequencies indicated that the SIP approach effectively identifies oil in low resistivity contrast zones when there is an oil-wet phase or component preset in the porous media. This is often the case in LRP zones where micro-porosity tends to be water-wet while macro-pores exhibit more oil-wet characteristics. Therefore, the SIP signals (impedance and real conductivity) can be utilized to make informed decisions based on a limited number of measurements taken at various frequency points, ranging up to 1000 Hz or 10,000 Hz.

According to aspects of the present disclosure, the SIP measurements obtained at various frequencies provided a more precise characterization of induced polarization effects, enabling the detection of oil, particularly at higher frequencies. The LRP zone sample was synthesized where the SIP method showed the potential to detect the presence of oil in the LRP zone. The impedance and real conductivity readings obtained from the SIP measurements exhibited a dispersion curve at higher frequencies, starting at 50 Hz, which indicated the presence of oil in the silica gel samples. This dispersion can be attributed to the polarization effects (such as EDL and Max-Wagner) within the oil-wet component, in this case, the addition of pyrite. The impedance and conductivity demonstrated consistent behavior across all channels, confirming the validity of the SIP measurements.

Silica gel saturated with brine-oil mix or fully brine displayed continuous impedance behavior due to the ongoing resistance phase at the analyzed frequencies. However, upon the addition of pyrite, the impedance increased with frequencies starting from 100 Hz and continuing up to the maximum measurement frequency of 10,000 Hz. In contrast, the real conductivity exhibited a decrease with increasing frequency, starting from 50 Hz, maintaining consistency with the impedance behavior. The tested approach has demonstrated the capability to address the challenge of LRP zones that can be used in a new well-logging tool for improved characterization and development of LRP reservoirs.

Similar to the DC resistivity method, frequency domain induced polarization can utilize surface or borehole electrodes to achieve improved resolution at greater depths. Electrodes are placed at specific intervals along the borehole or on the subsurface, and an electrical current is injected into the subsurface through the current electrodes. The resulting voltage distribution is measured by the potential electrodes. By analyzing the relationship between the injected current and the measured voltage, significant information about the subsurface, such as resistivity, porosity, and fluid content, can be determined. These electrical measurements provide valuable insights for geological and hydrological investigations, reservoir characterization, and resource exploration in a wide range of applications

In general, the SIP measurement procedure can include six phases, namely, a setup phase, a current injection phase, an impedance measurement phase, a frequency sweep, a data acquisition phase, and a data processing and analysis. During the measurement setup phase, electrodes are positioned on the ground surface or in boreholes. The electrode configuration is determined by the objectives, desired resolution and expected investigation depth. In the current injection phase, an electrical current is injected into the ground through the current electrodes. The current waveform typically consists of sinusoidal frequencies that cover the range of frequencies relevant to SIP measurements. The impedance measurement phase involves potential electrodes that measure the resulting phase shift and impedance distribution in the ground. These measurements are taken simultaneously with the current injection, enabling synchronized data acquisition. The frequency sweep phase involves repeating the current injection and measurements for multiple frequencies. The frequency sweep covers a wide range of frequencies to capture the spectral response of the subsurface. During the data acquisition phase, a system records the phase shift and impedance responses at each frequency. The measurements are usually digitized and stored for further analysis. Subsequently, in the data processing and analysis phase, the collected SIP data are processed and analyzed to extract meaningful information about the subsurface. This includes calculating the complex impedance or admittance at each frequency and converting them to various SIP parameters, such as phase shift and chargeability.

The present disclosure provides a method for identifying an LPR zone using the dispersion phenomenon. The experiments conducted using silica gel saturated with brine can be used to illustrate the applicability and efficiency of the method. These experiments provide valuable insights into the interactions between the brine and oil within a macro and micro-porosity system and how these interactions impact fluid flow and electrical resistivity. The findings and understanding gained from these silica gel experiments can be used to inform and contribute to the interpretation and design of field-scale studies, allowing researchers to make more informed decisions and predictions regarding fluid flow and transport phenomena in the oil and gas industry.

Numerous modifications and variations of the present disclosure are possible in light of the above teachings. It is therefore to be understood that within the scope of the appended claims, the invention may be practiced otherwise than as specifically described herein.

1. A method of formation characterization, the method comprising:
obtaining spectral induced polarization (SIP) measurements of a volume of a formation at a plurality of frequencies to determine a frequency-dependent complex (FDC) impedance value of a matrix material in the volume of the formation;
determining whether the volume is a low resistivity pay (LRP) zone with a formation resistivity index≤2, by analyzing the FDC impedance value of the matrix material; and
identifying the volume of the formation as the LRP zone when the FDC impedance value exhibits a dispersion at increasing frequencies,
wherein the FDC impedance value is substantially constant before the dispersion and increases by at least one order of magnitude over one order of magnitude of the increasing frequencies in the dispersion.

2. The method of claim 1, further comprising:
obtaining the SIP measurements of the volume of the formation using an SIP device that comprises:
an SIP column including a plurality of potential electrodes arranged along a longitudinal direction of the SIP column; and
two current electrodes positioned on opposing ends of the SIP column.

3. The method of claim 2, wherein obtaining the SIP measurements comprises:
obtaining a first set of SIP measurements between two potential electrodes of the plurality of potential electrodes; and
obtaining a second set of SIP measurements between another two potential electrodes of the plurality of potential electrodes.

4. The method of claim 1, further comprising:
placing potential electrodes and current electrodes adjacent to the volume of the formation;
injecting an alternating electrical current into the formation through the current electrodes at a first frequency; and
measuring a first set of data via the potential electrodes at a broad frequency range.

5. The method of claim 4, wherein:
the first set of data is at least one selected from the group consisting of a voltage distribution, a phase shift and an impedance distribution.

6. The method of claim 4, wherein:
the first electrical current has a current waveform of sinusoidal frequencies around the first frequency.

7. The method of claim 4, wherein:
the potential electrodes and the current electrodes are placed at intervals along a borehole adjacent to the volume of the formation or on a ground surface above the volume of the formation.

8. The method of claim 4, wherein:
injecting the alternating electrical current and measuring the set of data are executed simultaneously.

9. The method of claim 1, further comprising:
plotting the FDC impedance value against the plurality of frequencies; and
determining whether the FDC impedance value exhibits the dispersion at the increasing frequencies based on the plotting.

10. The method of claim 1, wherein the dispersion is exhibited above 50 Hz at the increasing frequencies.

11. The method of claim 10, wherein the dispersion is exhibited between 50 Hz and 1,000 Hz at the increasing frequencies.

12. The method of claim 1, wherein the plurality of frequencies includes a range sweep over 0.01-10,000 Hz.

13. The method of claim 1, wherein the plurality of frequencies includes a range sweep over 1-5,000 Hz.

14. The method of claim 1, wherein the plurality of frequencies includes no more than ten discrete frequencies between 0.01 Hz and 10,000 Hz.

15. The method of claim 1, wherein the plurality of frequencies includes no more than ten discrete frequencies between 1 Hz and 5,000 Hz.

16. The method of claim 1, further comprising:
analyzing a frequency-dependent real conductivity value of the matrix material in the volume of the formation; and
identifying the volume of the formation as the LRP zone when the frequency-dependent real conductivity value exhibits a dispersion effect at the increasing frequencies.

17. The method of claim 16, wherein:
the frequency-dependent real conductivity value decreases to zero as a result of the dispersion effect.

18. The method of claim 1, further comprising:
identifying the volume of the formation as the LRP zone when the FDC impedance value is substantially constant when the increasing frequencies are smaller than 10 Hz and increases by at least one order of magnitude between 10 Hz and 1,000 Hz.
